(19) United States
(12) Patent Application Publication
(10) Pub. No.: US 2005/0080716 A1
(43) Pub. Date: Apr. 14, 2005

(54) Data validation systems and methods for use in financial transactions

(76) Inventors: Boris Belyi, Houston, TX (US); Sharat Shankar, Littleton, CO (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/671,000

(22) Filed: Sep. 25, 2003

(51) Int. Cl. G06F 17/60

(52) U.S. Cl. 705/38

(57) ABSTRACT

A risk system that performs a risk assessment of a financial transaction to obtain a risk score. Based on the risk score, the risk system may request additional transaction information from a customer and/or a merchant. The request is based at least in part on financial transactions that are of moderate risk to thereby provide a non-cash payment acceptance service with more information to further evaluate the financial transaction risks. Thus, moderately risky financial transactions, that are likely to benefit the non-cash payment acceptance service and the merchant that subscribes to the non-cash payment acceptance service, are authorized for increased profitability and customer satisfaction. Furthermore, the risk system may approve or authorize financial transactions that generally fail standard risk assessments that use a cut-off risk score to divide the financial transactions into either approved or declined groups. As a result, the risk system is capable of re-evaluating some of the moderate risk cases for the purpose of securing beneficial financial transactions.

### RELATED APPLICATIONS

The subject matter of U.S. patent application Ser. No. ______ entitled DATA VALIDATION SYSTEMS AND METHODS FOR FINANCIAL TRANSACTIONS and having attorney Docket No. 1DATA.095A is related to this application and is hereby incorporated herein in its entirety.

### BACKGROUND OF THE INVENTION

1. Field of the Invention

The present invention relates to financial transactions and, in particular, to a system and method of risk assessment, whereby additional information is obtained from the customer and/or the merchant at a point of sale for validation of a financial transaction.

2. Description of the Related Art

A typical financial transaction involves a form of payment in exchange for goods and services at a point of sale. In most instances, a customer provides the form of payment, such as a check draft or credit card requisition, to a merchant in exchange for the goods and services. The check draft and the credit request are often regarded as non-cash promissory payments that instruct the customer's bank or credit guarantor to pay the merchant the amount requested by the customer. As is generally known, the funds promised to the merchant by the check draft or credit request are sometimes not paid due to reasons, such as insufficient funds in the customer's checking account, account delinquency, or fraud. Unfortunately, the merchant may be susceptible to risk when a check draft or credit card requisition is received as payment for goods and services.

Sometimes, the merchant may choose to manage risk by maintaining at least one local database that may include, for example, a list of customers that have written bad checks or provided fraudulent credit requests in the past. Such local databases may range in size from a simple list on paper for a small store owner to a computer network for a large chain store. Unfortunately, managing such local databases requires the use and divergence of merchant resources that could otherwise be utilized more beneficially.

Alternatively, the merchant may choose to manage risk by subscribing to a payment approval agency that assesses the risk associated with proffered payments, such as check drafts, credit card requisitions, or some other related payment method. An example of a risk assessment agency includes TeleCheck. For a given transaction, a subscribed merchant sends a transaction approval request to the agency with information, such as the payment amount and the method of payment identifying information. The agency assesses the risk and generates a risk score based on the information received. The agency then either approves or declines the transaction based on the generated risk score. The level of subscription to such an agency may vary, wherein the agency may assume the risk of the transaction by either guaranteeing the check or purchasing the check from the merchant. Thus, it is in the interest of the agency to accurately assess the risks associated with financial transactions.

A conventional non-cash payment approval process may include a cutoff risk score such that a transaction whose risk score is higher than the cutoff risk score is approved. Conversely, a transaction whose risk score is lower than the cutoff risk score is declined. In addition, a borderline risk score is positioned somewhere between the low risk score and the high risk score, which is somewhat near the cutoff risk score. Consequently, since the above-mentioned non-cash payment approval process is generally configured to statistically favor the merchant or the agency in terms of probable risk, borderline risk assessments are often declined in many check transactions that correspond to borderline risk scores.

For example, if the generated risk score is substantially equivalent to the cutoff risk score, which corresponds to a borderline or moderate risk score, then the merchant and/or the payment approving agency typically declines the financial transaction and the customer is required to present a cash payment or abandon the requested financial transaction altogether. In many cases, moderate risk situations result in lost revenue for the merchant and the agency due to the occurrence of borderline or moderate risk assessment declines.

In certain high risk environments, it may be necessary to issue a high number of risk based declines to protect the merchant and the payment approval agency from high returned check rates, delinquent credit accounts, and fraud. Unfortunately, issuing the high number of risk declines results in customers becoming irate, merchants losing sales, and interferes with the payment approval agency's ability to assess moderate risk at higher turndown levels. Therefore, some conventional payment approval agencies are substantially deficient in managing moderate risk transactions. Furthermore, the authorizational processing, temporal risk, and lack of flexibility to manage borderline risk assessments at the point of sale by conventional non-cash payment approval agencies may require significant improvement.

### SUMMARY OF THE INVENTION

The present invention provides a method and system which interacts with a merchant at the point of sale in financial transactions where additional information is required prior to authorizing the financial transaction due to borderline or moderate risk assessments. The aforementioned needs may be satisfied by a system for assessing risk in financial transactions wherein a customer is purchasing goods or services from a merchant and is proffering payment for the goods or services using a non-cash payment device. In one embodiment, the system for assessing risk in financial transactions may comprise a distributed network of point of sale devices that are distributed throughout a plurality of merchant locations, wherein the point of sale devices are configured to collect and transmit transaction information about the transaction and the proffered payment and are further configured to display requests to the merchant to provide identification information and to allow the merchant to transmit identification information via the point of sale device. In addition, the system for assessing risk in financial transactions may further comprise a risk assessment engine that receives the transmitted transaction information, evaluates the transmitted transaction information, and determines whether the proffered payment for the goods or services via the non-cash payment device should be accepted or declined, wherein the risk assessment engine provides a signal indicative of the acceptance or decline to the merchant via the distributed network of point of sale devices, and wherein the risk assessment engine requests additional identification information from the merchant at the point of sale device when the evaluation of the transmitted transaction information indicates that the proffered payment has a risk greater than a pre-selected threshold so as to further determine whether to accept or decline the proffered payment.

The aforementioned needs may also be satisfied by a system for assessing risk of a financial transaction, wherein a customer purchases merchandise or services from a merchant at a point of sale and proffers a payment in exchange for the merchandise or services. In one embodiment, the system for assessing risk of a financial transaction may comprise an interactive device positioned at the point of sale, wherein the interactive device interacts with the merchant at the point of sale by displaying messages in a manner so as to facilitate collection and transmission of information relating to the financial transaction including information about the proffered payment, and wherein the interactive device transmits information indicative of the merchant and the proffered payment. In addition, the system for assessing risk of a financial transaction may further comprise an authorization component that receives the transmitted information, generates a risk assessment based at least in part on the transmitted information, and determines from the risk assessment whether to approve or decline the financial transaction in a manner so as to provide a signal indicative thereof to the merchant via the interactive device, and wherein the authorization component requests additional information relating to the financial transaction from the merchant at the point of sale via the interactive device when the risk assessment indicates that the financial transaction is of moderate risk so as to further determine whether to accept or decline the financial transaction.

Moreover, the aforementioned needs may also be satisfied by a system for authorizing a financial transaction, wherein a non-cash payment is exchanged for goods and services. In one embodiment, the system for authorizing a financial transaction may comprise a merchant location comprising at least one interactive POS device, whereby messages can be displayed on the at least one interactive POS device prompting collection and transmission of transaction information relating to the financial transaction including information about the non-cash payment. In addition, the system for authorizing a financial transaction may further comprise a risk assessment component that generates at least one risk score based at least in part on the transmitted information, wherein the risk assessment component determines from the at least one risk score whether to approve or decline the financial transaction in a manner so as to provide a signal indicative thereof to the merchant location via the at least one interactive POS device. Also, the system for authorizing a financial transaction may still further comprise an interactive processing component associated with the risk assessment component that determines if additional information relating to the financial transaction is needed prior to authorization of the financial transaction, wherein the interactive processing component transmits a request for additional information to the merchant location via the interactive POS device in a manner so as to display the request on the interactive POS device when the at least one generated risk score is greater than a pre-selected threshold so that the risk assessment component can use the additional information to further determine whether to approve or decline the financial transaction.

Furthermore, the aforementioned needs may also be satisfied by a method of assessing risk in financial transactions, wherein goods or services are being purchased by a customer from a merchant by the customer proffering a promissory payment. In one embodiment, the method of assessing risk in financial transactions may comprise (i) transmitting transactional information about the proffered payment and the merchant to a risk assessment component, (ii) evaluating the proffered payment to assess the risk of accepting the proffered payment as payment for the goods or services, and (iii) transmitting an acceptance or decline decision to the merchant following the evaluation of the proffered payment to advise the merchant whether to accept the proffered payment. In addition, the method of assessing risk in financial transactions may further comprise (iv) requesting additional information from the merchant when the evaluation of the proffered payment indicates that the risk of accepting the payment falls within the moderate risk category, and (v) transmitting the additional information in response to the request of act (iv). These and other objects and advantages of the present invention will become apparent from the following description taken in conjunction with the accompanying drawings.

### BRIEF DESCRIPTION OF THE DRAWINGS

These and other aspects, advantages, and novel features of the invention will become apparent upon reading the following detailed description and upon reference to the accompanying drawings. In the drawings, similar elements have similar reference numerals.

FIG. 1 illustrates one embodiment of a financial transaction involving a customer providing a payment, a merchant having an interactive point of sale device, and a check acceptance service having an interactive authorization component.

FIG. 2 illustrates one embodiment of a schematic block diagram of the check acceptance service in FIG. 1 including a distributed network of interactive point of sale devices and a risk system having an interactive authorization module.

FIG. 3 illustrates one embodiment of a non-cash payment verification and approval process flow that describes an implementation of one aspect of the present invention by the check acceptance service using the risk system in FIG. 2.

FIG. 4 illustrates one embodiment of an interactive authorization process flow that utilizes the risk system, as referenced by FIG. 2, to selectively re-assess moderate risk financial transactions by obtaining additional point of sale transaction information from the customer and the merchant.

### DETAILED DESCRIPTION OF THE PREFERRED EMBODIMENT

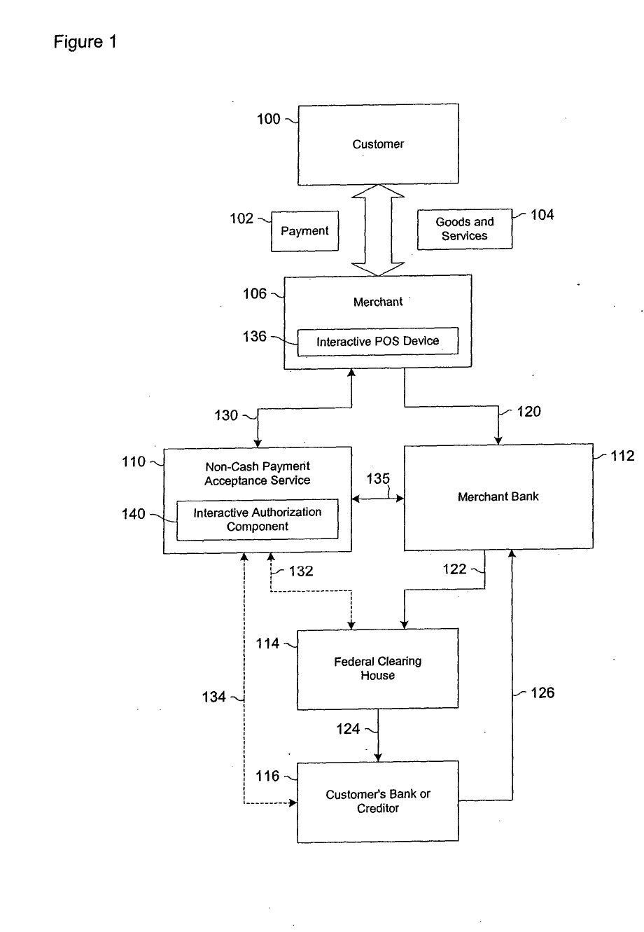

Reference will now be made to the drawings wherein like numerals refer to like parts throughout. FIG. 1 illustrates one embodiment of a financial transaction involving a customer providing a non-cash payment 102, a merchant 106 having an interactive point of sale (POS) device 136, and a non-cash payment acceptance service 110 having an interactive authorization component 140. In this particular embodiment, a customer 100 provides the non-cash payment 102, such as a promissory check draft or a credit card requisition to the merchant 106 or service entity in exchange for goods, merchandise, and/or services 104.

In one aspect, the payment 102 may be accepted and deposited into a merchant bank 112 without receiving any external authorization as indicated by path 120. In addition, the payment 102 may be electronically transferred through a clearing process, wherein the merchant bank 112 transfers the payment 102 to a federal clearing house (FCH) 114 as indicated by path 122. In turn, the federal clearing house 114 transfers the payment 102 to the customer's bank or creditor 116 as indicated by path 124. In one aspect, if the payment 102 is determined to be valid by the customer's bank or creditor 116, then the payment “clears” and the amount of the payment 102 is debited from the customer's account or credit line, and the debited amount is subsequently transferred from the customer's bank or creditor 116 to the merchant's 104 account in the merchant bank 112 as indicated by path 126.

In some financial transactions, the payment 102 may not clear for various reasons. As a result, the merchant's 106 bank account is not credited with the payment amount. For example, the customer's bank or creditor 116 may provide a non-sufficient fund (NSF) statement corresponding to the customer's 102 checking account, a stop payment request by the customer 100, a credit delinquency, or a fraudulent payment issuance. Unfortunately, if the payment 102 fails to clear, the merchant 106 is left with the responsibility of collecting the proper funds or the goods and services 104 from the customer 100. In some instances, the merchant 106 may be unsuccessful in reclaiming the proper funds in a collection process, and the already released goods and services 104 may be written off as a loss.

Alternatively, even when the merchant is successful in reclaiming the funds, the collection process significantly increases the merchant's 106 costs associated with the financial transaction. To reduce the occurrence of further loss from the same “bad” payment issuance by the customer 100, the customer's 100 name may be added to a negative list, such as an internal or local database. However, the local database may offer only limited protection against “bad” payment issuers, who may have previously bounced checks or offered fraudulent credit requisitions in the merchant's 106 establishment. Furthermore, “bad” payment issuers, who may not have previously bounced checks or offered fraudulent payments in the merchant's 106 establishment, but have a history of bouncing checks or offering fraudulent payments elsewhere, are unlikely to be detected by such a local database.

As a consequence, most merchants 106 may decide to subscribe to and rely on a non-cash payment acceptance service 110 to manage the risks associated with accepting non-cash payments from customers 100. The interaction between the merchant 106 and the non-cash payment acceptance service 110 is indicated by path 130. It should be appreciated that the scope of a subscription service that the merchant 106 subscribes to may vary depending on the needs of the merchant 106 without departing from the scope of the present invention.

In one embodiment, the subscription service may comprise the process of the non-cash payment acceptance service 110 informing the merchant 106 to accept or refuse the payment 102 based on the risk associated with the particular financial transaction. If the payment 102 is approved and accepted, the payment 102 is then transferred through the clearing process via the merchant bank 112 in a manner similar to that previously described above. Unfortunately, if the clearing process is not completed successfully, the merchant 106 usually assumes the risk associated with the financial transaction.

Another embodiment of the subscription service may comprise the process of the non-cash payment acceptance service 110 guaranteeing the validity of the payment 102 based on the risk associated with the particular financial transaction. In this instance, the payment 102 is transferred through the clearing process via the merchant bank 112 in a manner similar to the previous description. Fortunately for the merchant 106, if the payment 102 fails to clear, the non-cash payment acceptance service 110 credits the merchant 106 for the amount of the payment 102 and the non-cash payment acceptance service 110 assumes the responsibility of collecting the proffered payments funds from the customer 100.

For example, the payment 102 may be transferred from the non-cash payment acceptance service 110 to the federal clearing house (FCH) 114 as indicated by path 132. Then, the payment 102 may be transferred to the customer's bank or creditor 116 as indicated by the path 124. In this particular embodiment, if the payment 102 is valid or validity may be verified, the necessary funds are transferred from the customer's bank or creditor 116 to the non-cash payment acceptance service 110 as indicated by path 134. At this point, the financial transaction is regarded as complete for the non-cash payment acceptance service 110. However, if the payment 102 fails to clear with the customer's bank or creditor 116 of the customer 100, then the non-cash payment acceptance service 110 assumes the responsibility of collecting the necessary funds from the customer 100.

Still another embodiment of the subscription service may comprise the process of the non-cash payment acceptance service 110 purchasing the payment 102 outright from the merchant 106 based on the risk associated with the financial transaction; Beneficially, in this instance, the merchant 106 receives payment for the financial transaction upon approval or authorization from the non-cash payment acceptance service 110. Furthermore, in some cases, the non-cash payment acceptance service 110 may be electronically linked to the merchant bank 112, as indicated by path 135, to electronically transfer the necessary funds to the merchant's account in the merchant bank 112.

Various subscription services comprise diverse fee schedules that are significantly determined by the risks associated with the encountered financial transactions. It should be appreciated that the success of the non-cash payment acceptance service 110, including profitability, may substantially depend on accurate risk assessments that may be associated with non-cash proffered payment related financial transactions. For example, if the non-cash payment acceptance service 110 provides misguided or erroneous approval decisions to the merchant 106, then the merchant 106 accepts high risk proffered payments and/or refuses beneficial customers, which may result in lost revenue or dissatisfied customers. In other situations, the financial transaction risk is assumed by the non-cash payment acceptance service 110, wherein accurate risk assessments directly relate to profitability and success.

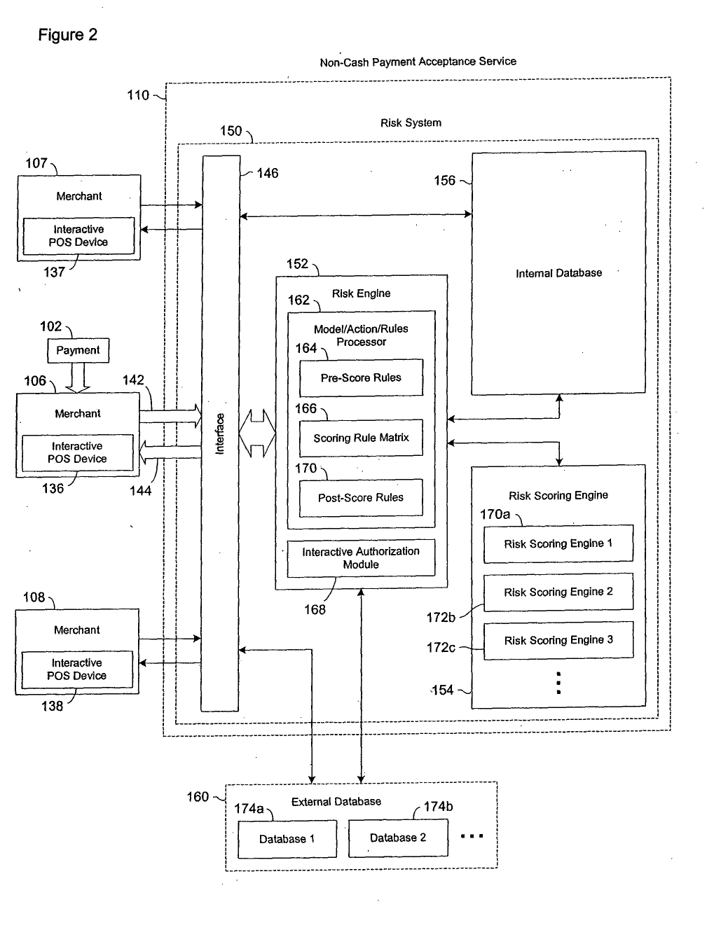

Additionally, FIG. 1 further introduces the technology associated with financial transactions and the electronic transfer of funds by a central financial transaction entity or the non-cash payment acceptance service 110 include monetary exchange devices, such as check readers, credit card readers, debit card readers, manual input of account information, or some combination thereof for the purpose of obtaining authorization for and settlement of financial transactions at the point of sale. Therefore, merchant based financial transfer systems may include the interactive POS device 136, which may include a display monitor, a printer, a magnetic card reader, and a magnetic check reader. In this particular embodiment of the present invention, the merchant 106 or merchant location is equipped with the interactive POS device 136, which may be used to bi-directionally communicate with an interactive authorization component 140 of the non-cash payment acceptance service 110 as will be described in greater detail herein below in FIG. 2.

For example, the payment 102 or a credit card may be presented by the customer 100 to the merchant 106 and scanned or swiped through the check reader or magnetic card reader, respectively. In one aspect, the check reader portion of the point of sale terminal identifies, by either magnetic ink character recognition (MICR) or optical character recognition (OCR), the American Banking Association (ABA) account information printed on the face of the check draft and converts the customer's ABA account information to transaction information, which may include digital signals or digital signatures. The transaction information may then be transferred from the interactive POS device 136 to the interactive authorization component 140 of the non-cash payment acceptance service 110 for authorization, processing and evaluation. In addition, the customer's transaction information, including banking and/or creditor account information, may be obtained by the merchant 106 via reading the magnetic strip of the customer's credit card with a magnetic card reader.

In some situations, if the initial risk assessment of the financial transaction is determined to produce a moderate risk exception, then the non-cash payment acceptance service may require additional transaction information, such as personal identification information, from the customer 100 prior to authorizing the financial transaction. Obtaining additional transaction information about the customer 100 may include obtaining and evaluating the customer's recent check writing history or recent credit requisition history to predict the risk associated with the financial transaction. In addition, the customer's check writing history or credit requisition history may be logged in an internal database, an external database, and/or saved as a merchant parameter in a memory component. Also, the additional transaction information may include verifying the existence of funds in the customer's bank account or availability of funds in the customer's credit line. Other identifying transaction information may include the customer's telephone number, place of residence including the zip code, passport, military identification number, and/or mother's maiden name.

Furthermore, the additional transaction information may include scanned images of the check draft or the credit card for review by the non-cash payment acceptance service 110. The scanned images may include points of interest on the check draft or credit card, such as the check number, the banking institution's logo, a photo of the customer on the credit card, the customer's signature, etc. It should be appreciated that the non-cash payment acceptance service 110 may ask for information that is already known prior to asking for or reviewing other previously described transaction information. It should also be appreciated that the above-mentioned financial transaction may comprise checking the credit worthiness of the customer for loan applications or any other type of credit applications involving a credit bureau, such as equifax, without departing from the scope of the present invention.

When moderate risk exceptions arise, the merchant 106 may be prompted by the interactive authorization component 140 via the interface and the interactive POS device 136 to input the requested additional transaction information for further risk analysis prior to authorizing the financial transaction. The additional transaction information allows the non-cash payment acceptance service 110 to selectively re-evaluate the financial transaction prior to issuing an approval or a decline. As a result, instead of issuing automatic risk declines for financial transactions that may be categorized as moderately risky, the non-cash payment acceptance service 110 may provide the merchant 106 a more accurately assessed response through the interactive POS device 136 after analyzing the additional transaction information. In some cases, the merchant 106 avoids issuing moderate risk declines, which results in reduced payment returns, increased customer satisfaction, and increased sales.

Advantageously, the above-mentioned financial transfer system represents a significant improvement over traditional non-cash payment handling procedures that, for example, require the transfer of a paper check among various financial institutions. The above-mentioned financial transfer system includes a mechanism for selectively re-evaluating borderline or moderate risk exception conditions, such as obtaining additional identification information through the interactive POS device 136. If borderline exception conditions or moderate risk assessment situations arise, the above-mentioned financial transfer system allows the merchant to bi-directionally communicate with the interactive authorization component 140 prior to authorizing the financial transaction in a manner such that the customer 100 is moderately inconvenienced, the merchant retains the merchandise until approval, and the payment acceptance service 110 reduces the potential loss of funds.

FIG. 2 illustrates one embodiment of a schematic block diagram of the non-cash payment acceptance service 110 of FIG. 1 with a distributed network of merchants 106, 107, 108 or merchant locations each having an interactive POS device 136, 137, 138, respectively. In particular, FIG. 2 illustrates interaction of the non-cash payment acceptance service 110 with the merchant 106 and the customer 100 in determining the risk associated with the financial transaction. In one aspect, the merchant 106 receives the payment 102 from the customer 100, and the merchant 106 electronically interacts with the non-cash payment acceptance service 110 to determine if the payment 102 will be accepted or declined. The interaction comprises financial transaction details 142 submitted by the merchant 106 to the non-cash payment acceptance service 110, and an approve or decline decision 144 provided by the non-cash payment acceptance service 110 to the merchant 106. The functionality and scope of the financial transaction, including the details 142 and the approve or decline decision 144, are described in greater detail herein below.

The non-cash payment acceptance service 110 further comprises a risk system 150 that may be utilized to determine and evaluate the risk associated with the financial transaction. In one embodiment, the risk system 150 interacts with the merchant 106 via an electronic interface 146 and the interactive POS device 136, such as a telephonic, satellite, and/or computer network (internet) interface. In particular, the interface 146 receives the financial transaction details 142 from the merchant 106 via the interactive POS device 136 and passes on the information to the risk system 150. Then, the risk system 150 may determine and evaluate the financial transaction in a manner described herein below. Furthermore, the risk system 150 returns the approve or decline decision 144 to the merchant 106 via the interface 146 and displays the applicable results on the display monitor of the interactive POS device 136. The display may comprise a video monitor, an liquid crystal display (LCD), or any other relevant type of display.

Additionally, the interface 146 may also access and retrieve relevant information about the customer 100, such as check writing history, and/or the merchant 106, such as a pre-determined limit on an acceptable check draft amount or credit requisition and other specific factors preferences, from an internal database 156. The interface 146 uses the relevant information to evaluate the customer 100 and/or merchant parameters so as to permit configuring the manner in which the risk assessment is performed by the risk system 150. Additionally, the risk system 150 is also configured so as to permit accessing of an external database 160, which may comprises a plurality of external databases 174a, 174b, etc. The external database 160 permits the risk engine 152 to gather relevant transaction information about the customer 100 and the merchant 106 that may not necessarily be available in the internal database 156, so as to further facilitate the risk assessment.

Moreover, the risk system 150 further comprises a risk engine 152 that evaluates the risk assessment of the financial transaction based on the financial transaction details 142 or transaction data transferred from the interface 146, the internal database 156, and the external database 160. The risk scoring engine 154 may determine a risk score at the request of the non-cash payment acceptance service 110 and returns the risk score indicative of a probable risk assessment of the financial transaction. Advantageously, the risk scoring engine 154 may comprise a plurality of scoring engines 172a, 172b, 172c, etc., wherein each risk engine is adapted to address a plurality of possible financial transactions or transaction variables in a manner so as to permit improved accuracy in determining the risk score. Various types of scoring engines that may be utilized by the risk engine will be described in greater detail herein below. In addition, a preferred financial transaction that illustrates selective use of the plurality of scoring engines will be described in greater detail herein below.

Furthermore, the risk engine 152 further comprises a Model/Action/Rules processor 162 that may be utilized to evaluate the transaction risk and may determine whether to approve or decline the financial transaction. The processor 162 comprises a pre-score rules module 164, a scoring rule matrix module 166, a post-score rules module, and an interactive authorization module 168. The pre-score rules module 164 is utilized to initially determine whether risk evaluation needs to be performed. For example, the risk engine 150 may access the internal database 156 for transaction information about the customer, and ascertains whether the customer 100 is associated with a hard negative check writing history or credit requisition history. In this particular case, the hard negative check writing history or credit requisition history arises from writing at least one non-clearable check draft or credit requisition and, in some cases, refuses to provide legitimate compensation during the collection process. As a result, the pre-score rules module 164 may then decide that the financial transaction is of high risk and, in which case, subsequently declines authorization due to an unacceptable risk assessment ascertained for the customer 100.

It should be appreciated that the risk system 150 may store in a memory component or database, such as the internal database 156, transaction information of the customer 100 that may be requested by the risk assessment engine. In one aspect, transaction information comprises information that identifies the customer 100 so as to facilitate the collection process on the non-cash proffered payment 102. Moreover, the risk system 150 may use the memory component or database to facilitate subsequent collection on the non-cash proffered payment 102 from the customer 100 in the event that the non-cash proffered payment 102 fails to clear and is returned to the non-cash payment acceptance service 110.

Additionally, the scoring rule matrix module 166 includes a plurality of rules and utilizes the plurality of rules for the purpose of selecting a relevant scoring engine to obtain an initial risk score. Based on the initial risk score, the scoring rule matrix module 166 may approve or decline the financial transaction.

Furthermore, the post-score rules module 170 may be utilized to evaluate the initial risk score, that was generated by the scoring matrix 166, to determine if further risk assessment needs to be performed. In particular, the post-score rules module 170 may selectively determine a second scoring engine to run so as to obtain an additional risk score. In one aspect, the additional risk score assessment is performed if the initial risk score leads to a transaction decline according to the scoring rule matrix 166. In another embodiment, the additional risk assessment is performed if the initial risk score falls within a predetermined range of risk score threshold values. It should be appreciated that the additional risk assessment performed may be selectively implemented in any number of situations so as to accurately assess the financial transaction risk.

In one aspect, examples and functionality of an exemplary risk assessment may be configured in accordance with methods described in the Applicant's co-pending U.S. patent application entitled “SYSTEMS AND METHODS FOR SELECTIVE USE OF RISK MODELS TO PREDICT FINANCIAL RISK”, Attorney Docket No. 1DATA.045A, which is incorporated herein by reference in its entirety. Some rules invoke other rules based on simple decisions, and some rules invoke scoring engines to determine risk related factors. It should be emphasized that the rules and the scoring engines illustrated and described in reference to the Applicant's co-pending application are not intended to limit the scope of the risk system. Thus, it should be appreciated that the rules and scoring engines exemplified in the Applicant's co-pending application illustrate one embodiment of the risk assessment associated with the financial transaction described herein below.

In some circumstances, a profitability assessment may be performed in place of or in addition to a risk assessment. In one aspect, a profitability assessment scores the ability of the non-cash payment acceptance service 110 to collect the returned payment funds plus service fees from the customer 100. For example, if the customer 100 has a proven history of paying the returned payment funds plus service fees on a historical basis, then the risk system 150 may determine that acceptance of the proffered payment 102 would likely be profitable for the non-cash payment acceptance service 110. Examples and functionality of an exemplary profitability assessment may be configured in accordance with methods described in the Applicant's co-pending U.S. patent application entitled “SYSTEMS AND METHODS FOR PREDICTING THE PROFITABILITY OF FINANCIAL TRANSACTIONS”, Attorney Docket No. 1DATA.048A, which is incorporated herein by reference in its entirety.

The interactive authorization module 168 may be utilized to prompt the merchant 106 with a notification of a requirement for additional transaction information, including personal identification information. In some cases, if the risk engine 152 determines that the financial transaction produces a borderline or moderate risk exception condition, then the interactive authorization module 168 may issue the notification for additional transaction information to be inputted by the merchant 106 via the interactive POS device 136. In one aspect, the notification for additional transaction information inform the merchant 106 that additional risk assessment and evaluation is necessary prior to transaction authorization. At this point, the merchant 106 inputs the additional transaction information into the interactive POS device 136 and then waits for the non-cash payment acceptance service 110 to issue authorization or declination for the financial transaction.

It should be appreciated that the merchant 106 may elect to exchange the goods, merchandise, and/or services after a pre-selected period of time if authorization notification was not issued by the non-cash payment acceptance service 110 during the pre-determined period of time. It should also be appreciated that authorizing the financial transaction after the pre-selected period of time may include an agreement between the non-cash payment acceptance service 110 and the merchant 106 that unless the merchant 106 is advised to not to deliver the goods, merchandise, and/or services at the end of the pre-selected period of time, the delivery of the merchandise is authorized. As a result, the advantage is that the merchant 106 retains the goods, merchandise, and/or services, the customer 100 is satisfied with the service, and the non-cash payment acceptance service 110 is given additional time to analyze and evaluate the additional transaction information prior to approval or decline.

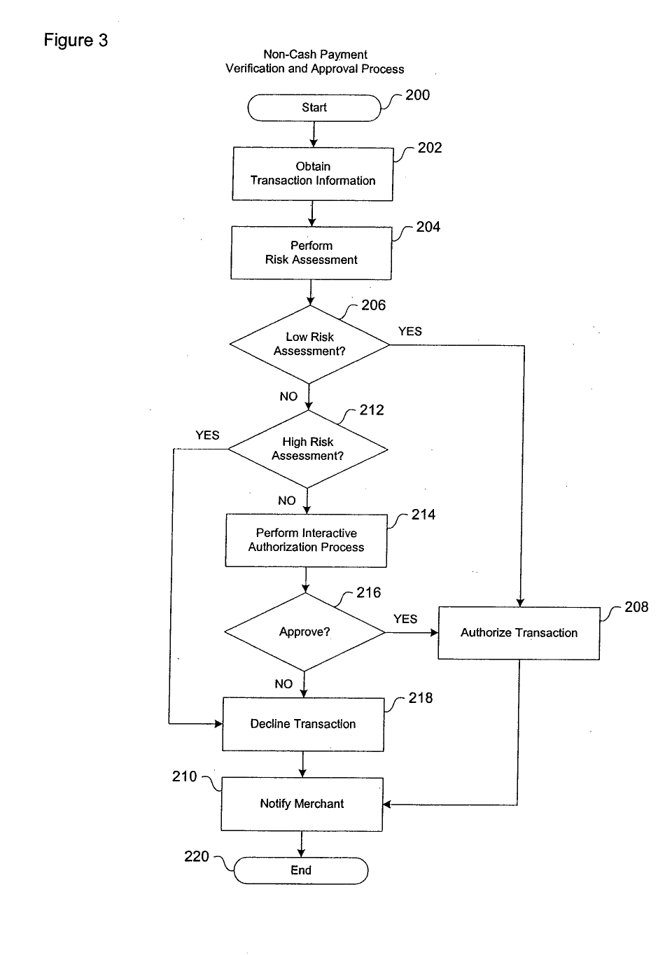

FIG. 3 illustrates one embodiment of a non-cash payment verification and approval process flow that describes an implementation of one aspect of the present invention by the non-cash payment acceptance service 110 using the risk system in FIG. 2. The non-cash payment verification and approval process flow functionally describes one embodiment of risk assessment, wherein risk scores and personal identification information may be utilized to determine and evaluate the degree of risk for a given financial transaction between the merchant 106 and the customer 100. In moderate risk assessment cases, the risk system 150 may require additional transaction information prior to authorization in a manner as previously described. Additionally, low risk assessment cases are approved and high risk assessment cases are declined in a manner such that the approved or declined status may be based on customer check writing history, customer credit requisition history, risk score evaluation, profitability analysis, or some other factor relevant to the risk assessment of the financial transaction between the merchant 106 and the customer 100.

The non-cash payment verification and approval process initiates in a start state 200 and proceeds to a state 202. In the state 202, the risk system 150 obtains transaction data, information, and other details relating to the financial transaction from the merchant 106 via the interactive POS device 136 and the interface 146. Related transaction information may include the customer's name, the customer's account number, and the amount of the proffered payment. In one aspect, the non-cash payment acceptance service 110 may obtain the customer's transaction information via the telephone, input on a web page via the internet, or by mail and then transfer the information to the risk system 150 via keyboard input. In a preferred embodiment, the transaction information is inputted into the interactive POS device 136 and then transferred to the risk system 150 via the interface 146.

Additionally in the state 202, the non-cash payment acceptance service 110 may access the merchant 106 record, such as transaction history with the particular customer 100, and determine the merchant's parameters. The merchant parameters may include preference thresholds or classifications for determining low, moderate, and high risk assessment values. The merchant parameters may further include preferred risk engines, internal databases, and external databases to be used when evaluating risk for a particular financial transaction. It should be appreciated that the merchant record and parameters may be saved in a memory device and accessed whenever the merchant requests approval for a financial transaction.

Next, in a state 204 that follows, the risk system 150 pre-processes the transaction information by generating an initial risk assessment for the financial transaction. Based on the initial risk assessment, the risk system 150 utilizes the risk scoring engine 154 to obtain an initial risk score in a manner that will be described in greater detail herein below. Then, the non-cash payment verification and approval process advances to a decision state 206.

In one aspect, the risk system 150 performs the initial risk assessment in the state 204 as follows. In the state 204, the risk system 150 receives transaction variables and merchant parameters from the interface 146. Then following, the risk system 150 may access the internal database 156 for the transaction records of the customer 100 and the merchant 106. Next, the risk system 150 may decide whether to proceed with the risk evaluation, based on the pre-score rules as described in the Applicant's co-pending U.S. patent application entitled “SYSTEMS AND METHODS FOR SELECTIVE USE OF RISK MODELS TO PREDICT FINANCIAL RISK”, Attorney Docket No. 1DATA.045A. In most instances, a hard negative decision or high risk assessment may lead to an automatic return of an applicable result to the interface 146, wherein the hard negative or high risk assessment corresponding to the customer 100 may lead to a decline decision status without further action by the risk system 150.

Alternatively, if the risk system 150 decides to commence with a risk assessment, then the risk system 150 proceeds to evaluate the financial transaction and select a scoring engine to run based on the transaction variables and the rules of the scoring rule matrix as described in the Applicant's co-pending U.S. patent Application entitled “SYSTEMS AND METHODS FOR SELECTIVE USE OF RISK MODELS TO PREDICT FINANCIAL RISK”, Attorney Docket No. 1DATA.045A. The scoring engine 154 of the risk system 150 scores the transaction risk and returns the risk score in a state 212.

In addition, the risk system 150 may evaluate the risk score based on the post-score rules, as described in the Applicant's co-pending U.S. patent application entitled “SYSTEMS AND METHODS FOR SELECTIVE USE OF RISK MODELS TO PREDICT FINANCIAL RISK”, Attorney Docket No. 1DATA.045A. In this particular instance, the risk system 150 may ascertain whether to perform an additional risk assessment or suspend the financial transaction for further evaluation, in which case a notification for additional transaction information may be provided to the merchant 106 as previously described.

Furthermore, following the selection of a scoring engine, the risk system 150 may access external databases for additional transaction information if necessary, and the risk system 150 may perform additional risk modeling or assessment with the selected scoring engine. Therefore, the additional risk score resulting from the additional risk modeling may then be evaluated by the risk system 150 based on the post-score rules. After additional risk assessment and evaluation is complete, the risk system 150 may determine whether further risk assessment is needed and return the applicable result to the interface 146.

In one embodiment, the additional risk assessment is performed in a manner such that the applicable result is returned after at least two risk assessments. In another embodiment, the additional risk assessment is performed one or more times as needed. It should be appreciated that selective actions taken by the risk system 150 according to the post-score rules may be considered consistent with the scope of the present invention. Thus, even if no additional risk assessment if performed based on the initial risk score and the post-score rules, such as the initial risk score being of high risk or of low risk for example, the selective decision process performed by the risk system 150 is consistent with one aspect of the present invention described herein. It should also be appreciated that, based upon the initial risk score and/or the additional risk score, a notification for additional transaction information may be provided to the merchant 106 for the purpose of performing additional risk assessment prior to authorization in a manner as previously described.

Once the risk assessment is performed and the risk score is generated in the state 204, the non-cash payment verification and approval process advances to the decision state 206. In the decision state 206, the risk system 150 determines and evaluates the degree of the generated risk score. In one aspect, the risk system 150 may compare the initial risk score with a pre-determined range of low risk assessment threshold values. For example, the low risk assessment threshold values may range between 700 and 1000 on a scale of 0 (zero) to a 1000. In addition, if the processor 162 determines from the comparison that the financial transaction is of low risk, then the non-cash payment verification and approval process advances to a state 208 to approve the financial transaction. Subsequently, in a state 210, the non-cash payment acceptance service 110 authorizes the financial transaction and notifies the merchant 106 with an applicable result via the interactive POS device 136. Then, in an end state 220, the non-cash payment verification and approval process terminates. It should be appreciated that the pre-determined range of low risk assessment threshold values may comprise any range of values or parameters set by the merchant 106, the non-cash payment acceptance service 110, and/or any other guidelines available without departing from the scope of the present invention.

Alternatively, in the decision state 206, if the initial risk score fails to fall in the pre-determined range of low risk assessment threshold values, then the non-cash payment verification and approval process advances to another decision state 212. In the decision state 212, the risk system 150 compares the initial risk score with a pre-determined range of high risk assessment threshold values. For example, the high risk assessment threshold values may range between 0 (zero) and 500 on a scale of 0 (zero) to a 1000. If the risk system 150 determines from the comparison that the financial transaction is of high risk, then the non-cash payment verification and approval process advances to a state 218 to decline the financial transaction. In which case, the non-cash payment verification and approval process terminates in the following end state 220. It should be appreciated that the pre-determined range of high risk assessment threshold values may comprise any range of values or parameters set by the merchant 106, the non-cash payment acceptance service 110, and/or any other guidelines available without departing from the scope of the present invention.

Otherwise, if the comparison is determined not to comprise a high risk assessment score, then the non-cash payment verification and approval process proceeds to a state 214. In one aspect, if the risk score is not a low risk score or a high risk score, then the risk score is assumed to be a borderline or moderate risk score. For example, moderate risk assessment threshold values may range between 500 and 700 on a scale of 0 (zero) to a 1000, wherein the moderate risk scores fall between the low risk assessment cut-off value (700) and the high risk cut-off value (500). As previously described, borderline or moderate risk assessment scores may require additional transaction information prior to approval.

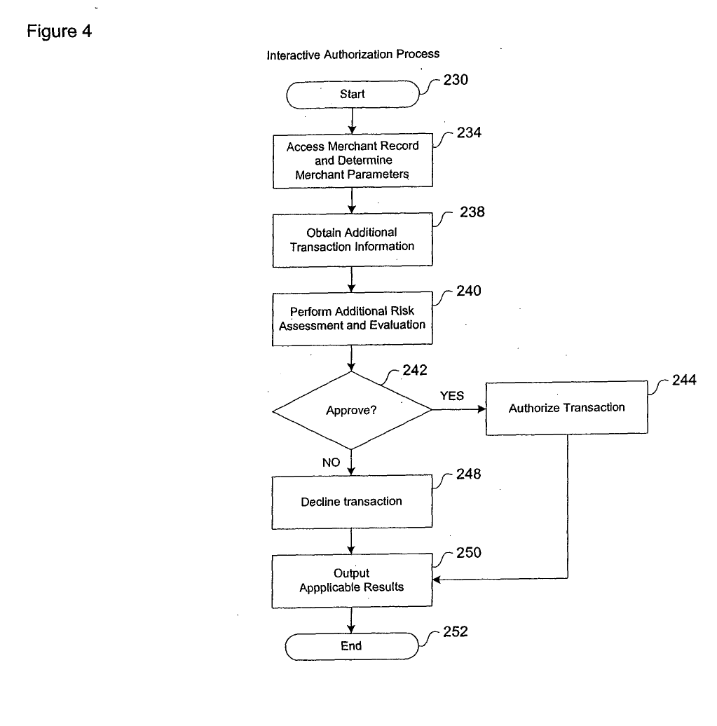

In the state 214, the non-cash payment acceptance service 110 provides the merchant 106 with a notification for additional transaction information in a manner as previously described. Additionally, in the state 214, the risk system 150 performs the interactive authorization process in a manner that will be described in greater detail herein below in reference to FIG. 4. If, based on the interactive authorization process, approval is authorized in still another decision state 216, then the non-cash payment verification and approval process advances to the state 208, where the non-cash payment acceptance service 110 authorizes the financial transaction between the merchant 106 and the customer 100. Then, in the state 210, the non-cash payment acceptance service 110 authorizes the financial transaction and notifies the merchant 106 with an applicable result via the interactive POS device 136. After notifying the merchant 106 in the state 210, the process terminates in the end state 220. However, if the approval is not granted to the merchant 106 in the decision state 216, then the risk system 150 declines the financial transaction in the state 218, and the process subsequently terminates in the end state 220.

In an alternative embodiment, the risk system 150 performs an additional risk score assessment after the initial risk score prior to performing the interactive authorization process in the state 214. In still another embodiment, the risk system 150 may perform a plurality of additional risk assessments for the purpose of more accurately assessing the degree of risk of the financial transaction. In addition, multiple risk assessments may be performed, for example, on financial transactions that involve large check draft amounts or large credit requisition amounts. It should be appreciated that the risk system 150 may perform any number of additional risk assessments on any number of types of financial transactions without departing from the scope of the present invention.

Advantageously, the above-mentioned risk assessment procedure, method, and system represents a significant improvement over traditional non-cash payment handling procedures that automatically approve or decline borderline or moderate risk assessments. Additionally, the above-mentioned risk assessment procedure, method, and system utilizes an efficient and selective mechanism for evaluating borderline or moderate exception conditions, such as the notification for additional transaction information prior to authorization. For example, if borderline exception conditions or moderate risk assessment situations arise, the above-mentioned non-cash payment verification and approval process selectively re-evaluates the risk associated with the additional transaction information prior to authorizing the financial transaction between the merchant 106 and the customer 100.

FIG. 4 illustrates one embodiment of an interactive authorization process flow that utilizes the risk system 150, as referenced by FIG. 2, to selectively re-assess moderate risk financial transactions by obtaining additional point of sale transaction information from the customer 100 and the merchant 106. The interactive authorization process, as described herein below, is one embodiment of a functional process flow description of the state 214 in FIG. 3. In one aspect, financial transactions that involve non-cash proffered payments and moderate risk assessments may require additional transaction information from the customer 100 and/or the merchant 106 for further risk evaluation including the verification of funds prior to the release of the goods, merchandise, and/or services 104. Sometimes a moderately risky customer 100 may make good on their promissory payments. Therefore, a merchant 106 increases its profitability by accepting some moderately risky financial transactions by utilizing the interactive authorization process as described herein below.

The interactive authorization process initiates in a start state 230, and then advances to a state 234, where the non-cash payment acceptance service 110 accesses the merchant 106 record, such as transaction history with the particular customer 100, and determines the merchant's parameters in a manner as previously described. Following, in a state 238, the non-cash payment acceptance service 110 requests for additional transaction information from the customer 100 and/or the merchant 106 via the interactive POS device 136 in a manner as previously described. Next, in a state 240, the risk system 150 performs at least one additional risk assessment and evaluation using the additional transaction information received from the customer 100 and/or merchant 106 via the interactive POS device 136. At this point in the process, it should be appreciated that the risk system 150 may selectively elect to perform still another risk assessment similar to the risk assessment performed in the state 204 of FIG. 3 without departing from the scope of the present invention. As a result, any additional risk assessments may or may not utilize the additional transaction information.

Subsequently, in a decision state 242, if the risk system 150 approves the financial transaction, which may be based at least in part on the additional transaction information, then the interactive authorization process advances to a state 244, where the financial transaction is authorized. Moreover, if the financial transaction is approved in the state 244, then the approved results are electronically transferred to the merchant 106 via the interface 146 and display the applicable results on the interactive POS device 136 in a manner as previously described with reference to FIGS. 1, 2. Following the transfer of the applicable results to the merchant 106, the interactive authorization process terminates in an end state 252. It should be appreciated that the merchant 106 may be notified of the applicable results of the financial transaction via the telephone, satellite relay, standard mail, or the internet without departing from the scope of the present invention.

Alternatively, if the financial transaction is not approved by the risk system 150 in the decision state 242, then the interactive authorization process advances to a state 248, where the risk system 150 provides a declined status to the merchant 106 in a manner as previously described, such as electronically via the interactive POS device 136. Following the transfer of the applicable results to the merchant 106, the interactive authorization process terminates in an end state 252. By requesting additional transaction information prior to authorizing the financial transaction, the non-cash payment acceptance service 110 is given the opportunity to selectively re-assess the financial transaction with the additional transaction information.

In one aspect, additional risk assessment and evaluation may include verifying the existence of funds with the customer's bank or creditor in a manner as described in FIG. 1. Furthermore, obtaining additional financial information about the customer in the state 238 may also comprise obtaining information about the customer's recent non-cash proffered payment history to predict whether there will be sufficient funds to cover the cost of the financial transaction. The customer's non-cash proffered payment history may be logged in the internal database 156, the external database 160, and/or saved as a merchant parameter.

Furthermore, the additional transaction information obtained from the customer 100 may include a driver's license number, a mother's maiden name, a date of birth, a social security number, previous residential addresses, and/or scanned images of the check draft or credit requisition. By obtaining the additional transaction information, the non-cash payment acceptance service 110 may perform a more in depth risk assessment by generating additional risk scores and accessing more external databases for non-cash payment history evaluation, which may result in more successfully avoiding fraudulent based financial transactions.

In some cases, if the financial transaction is not approved in the decision state 242, the risk system 150 may decide to perform more additional processing of the transaction information including the previous risk assessments. If additional processing is performed, then the processing is performed in the state 240. Otherwise, if the additional processing is not performed, then the financial transaction is declined in the state 248, and the applicable results are sent to the merchant 106 via the interactive POS device 136 in the state 250. Subsequently, the interactive authorization process terminates in the end state 252.

Advantageously, the interactive authorization process may be utilized to increase revenue in financial transactions where moderate risk assessments occur. For example, the above-mentioned risk assessment procedures, methods, and systems utilizes an efficient and selective mechanism for evaluating borderline exception conditions and moderate risk assessments, such as utilizing the interactive authorization process. In one aspect, if moderate risk assessment situations arise, the above-mentioned non-cash payment verification and approval procedures, methods, and systems selectively requests additional transaction information from the customer 100 and/or the merchant 106 prior to authorizing the financial transaction in a manner such that the customer is moderately inconvenienced, the merchant retains the goods, merchandise and/or services, and the non-cash payment acceptance service reduces the potential loss of funds.

Although the following description exemplifies one embodiment of the present invention, it should be understood that various omissions, substitutions, and changes in the form of the detail of the apparatus, system, and/or method as illustrated as well as the uses thereof, may be made by those skilled in the art, without departing from the spirit of the present invention. Consequently, the scope of the present invention should not be limited to the disclosed embodiments, but should be defined by the appended claims.

1. A system for assessing risk in financial transactions wherein a customer is purchasing goods or services from a merchant and is proffering payment for the goods or services using a non-cash payment device, the system comprising:
a distributed network of point of sale devices that are distributed throughout a plurality of merchant locations, wherein the point of sale devices are configured to collect and transmit transaction information about the transaction and the proffered payment and are further configured to display requests to the merchant to provide identification information and to allow the merchant to transmit identification information via the point of sale device; and
a risk assessment engine that receives the transmitted transaction information, evaluates the transmitted transaction information, and determines whether the proffered payment for the goods or services via the non-cash payment device should be accepted or declined, wherein the risk assessment engine provides a signal indicative of the acceptance or decline to the merchant via the distributed network of point of sale devices, and wherein the risk assessment engine requests additional identification information from the merchant at the point of sale device when the evaluation of the transmitted transaction information indicates that the proffered payment has a risk greater than a pre-selected threshold so as to further determine whether to accept or decline the proffered payment.

2. The system of claim 1, wherein the non-cash payment device comprises a payment by check, wherein the risk assessment engine evaluates the risk of accepting the check.

3. The system of claim 2, wherein the transmitted transaction information comprises at least one of the check amount, an identification of the merchant, and check identification information.

4. The system of claim 3, wherein the check identification information comprises a MICR code from the check.

5. The system of claim 1, wherein the additional identification information requested by the risk assessment engine comprises information that identifies the customer so as to facilitate collection on the check.

6. The system of claim 1, further comprising a database, wherein the transmitted transaction information and the additional identification information is stored in the database to facilitate subsequent collection on the check from the customer in the event that payment is not made on the check.

7. The system of claim 1, wherein the additional identification information is the customer's telephone number.

8. The system of claim 2, wherein the risk assessment engine determines whether the additional identification information corresponds to the check identification information in determining whether to accept or decline the proffered payment following receipt of the additional identification information.

9. The system of claim 8, wherein the risk assessment engine determines whether the additional identification information identifies a customer that is authorized to write checks on the account corresponding to the check.

10. The system of claim 2, wherein the check is a credit card, wherein the risk assessment engine evaluates the risk of accepting the credit card.

11. The system of claim 10, wherein the transmitted transaction information comprises at least one of the purchase amount, an identification of the merchant, and credit card identification information related to the customer.

12. The system of claim 11, wherein the credit card comprises a magnetic strip, and the credit card identification information comprises magnetically stored digital information that is obtained from the magnetic strip on the credit card.

13. A system for assessing risk of a financial transaction, wherein a customer purchases merchandise or services from a merchant at a point of sale and proffers a payment in exchange for the merchandise or services, the system comprising:
an interactive device positioned at the point of sale, wherein the interactive device interacts with the merchant at the point of sale by displaying messages in a manner so as to facilitate collection and transmission of information relating to the financial transaction including information about the proffered payment, and wherein the interactive device transmits information indicative of the merchant and the proffered payment; and
an authorization component that receives the transmitted information, generates a risk assessment based at least in part on the transmitted information, and determines from the risk assessment whether to approve or decline the financial transaction in a manner so as to provide a signal indicative thereof to the merchant via the interactive device, and wherein the authorization component requests additional information relating to the financial transaction from the merchant at the point of sale via the interactive device when the risk assessment indicates that the financial transaction is of moderate risk so as to further determine whether to accept or decline the financial transaction.

14. The system of claim 13, wherein the authorization component notifies the merchant by displaying a request for additional information on the interactive device prior to authorizing the financial transaction.

15. The system of claim 13, wherein the proffered payment is a check.

16. The system of claim 13, wherein the proffered payment is a credit card.

17. The system of claim 13, wherein the information is transmitted electronically through a computer network.

18. The system of claim 13, wherein the transmitted information includes at least one of the payment amount, payment identification information, and merchant identification.

19. The system of claim 18, wherein the payment identification information includes a MICR code of the payment.

20. The system of claim 18, wherein the payment identification information includes an OCR code of the payment.

21. The system of claim 18, wherein the payment identification information includes an image of the payment.

22. The system of claim 18, wherein the authorization component determines whether the additional information corresponds to the payment identification information so as to determine whether to accept or decline the proffered payment following receipt of the additional information.

23. The system of claim 18, wherein the additional information includes personal identification information that identifies the customer, and wherein the authorization component determines whether the additional information identifies the customer and whether the customer is authorized to use the account corresponding to the payment.

24. The system of claim 22, wherein the personal identification information is selected from the group consisting of the customer's telephone number, the customer's mother's maiden name, the customer's place of residence, the customer's zip code, the customer's driver's license number, and a personal identification number (PIN).

25. The system of claim 13, wherein the authorization component further comprises a database, and wherein the database stores the transmitted information and the additional information to facilitate collection of a returned payment from the customer in the event that funds are not collected from the payment.

26. The system of claim 13, wherein the interactive device comprises at least one of a display monitor, a key input device, a printer, a magnetic card reader, and a magnetic check reader.

27. The system of claim 13, wherein the signal is a message notifying the merchant to approve or decline the financial transaction.

28. A system for authorizing a financial transaction, wherein a non-cash payment is exchanged for goods and services, the system comprising:
a merchant location comprising at least one interactive POS device, whereby messages can be displayed on the at least one interactive POS device prompting collection and transmission of transaction information relating to the financial transaction including information about the non-cash payment;
a risk assessment component that generates at least one risk score based at least in part on the transmitted information, wherein the risk assessment component determines from the at least one risk score whether to approve or decline the financial transaction in a manner so as to provide a signal indicative thereof to the merchant location via the at least one interactive POS device; and
an interactive processing component associated with the risk assessment component that determines if additional information relating to the financial transaction is needed prior to authorization of the financial transaction, wherein the interactive processing component transmits a request for additional information to the merchant location via the interactive POS device in a manner so as to display the request on the interactive POS device when the at least one generated risk score is greater than a pre-selected threshold so that the risk assessment component can use the additional information to further determine whether to approve or decline the financial transaction.

29. The system of claim 28, wherein the merchant location transmits the additional information relating to the financial transaction to the risk assessment component after receiving the request for additional information.

30. The system of claim 28, wherein the non-cash payment comprises a payment by check, wherein the risk assessment component evaluates the risk of accepting the check.

31. The system of claim 30, wherein the transmitted transaction information comprises at least one of the check amount, an identification of the merchant, and check identification information.

32. The system of claim 31, wherein the check identification information comprises a MICR code from the check.

33. The system of claim 32, wherein the risk assessment component determines whether the additional information corresponds to the check identification information in determining whether to accept or decline the non-cash payment following receipt of the additional information.

34. The system of claim 33, wherein the risk assessment component determines whether the additional information identifies a customer that is authorized to write checks on the account corresponding to the check.

35. The system of claim 28, wherein the additional information requested by the interactive processing component comprises information that identifies the customer so as to facilitate collection on the non-cash payment.

36. The system of claim 28, further comprising a database, wherein the transmitted transaction information and the additional information is stored in the database to facilitate subsequent collection on the non-cash payment from the customer in the event that funds are not collected on the non-cash payment.

37. The system of claim 28, wherein the additional information is the customer's telephone number.

38. The system of claim 28, wherein the non-cash payment is a credit card, wherein the risk assessment component evaluates the risk of accepting the credit card.

39. The system of claim 38, wherein the transmitted transaction information comprises at least one of the purchase amount, an identification of the merchant, and credit card identification information related to the customer.

40. The system of claim 39, wherein the credit card comprises a magnetic strip, and the credit card identification information comprises magnetically stored digital information that is obtained from the magnetic strip on the credit card.

41. A method of assessing risk in financial transactions, wherein goods or services are being purchased by a customer from a merchant by the customer proffering a promissory payment, the method comprising:
(i) transmitting transactional information about the proffered payment and the merchant to a risk assessment component;
(ii) evaluating the proffered payment to assess the risk of accepting the proffered payment as payment for the goods or services;
(iii) transmitting an acceptance or decline decision to the merchant following the evaluation of the proffered payment to advise the merchant whether to accept the proffered payment;
(iv) requesting additional information from the merchant when the evaluation of the proffered payment indicates that the risk of accepting the payment falls within the moderate risk category; and
(v) transmitting the additional information in response to the request of act (iv).

42. The method of claim 41, wherein transmitting the acceptance or decline decision to the merchant is based at least in part on the additional information.

43. The method of claim 41, wherein proffering the promissory payment includes proffering a payment by check, wherein evaluating the payment by check includes assessing the risk of accepting the check.

44. The method of claim 43, wherein transmitting transactional information includes transmitting a MICR code from the check.

45. The method of claim 44 wherein requesting additional information includes requesting at least one of the check amount, an identification of the merchant, and check identification information.

46. The method of claim 45, wherein requesting additional information includes requesting information that identifies the customer so as to facilitate collection on the check.

47. The method of claim 46, wherein evaluating the proffered payment to assess the risk includes determining whether the additional information corresponds to the check identification information in determining whether to accept or decline the proffered payment following receipt of the additional information.

48. The method of claim 47, wherein evaluating the proffered payment to assess the risk includes determining whether the additional information identifies a customer that is authorized to write checks on the account corresponding to the check.

49. The method of claim 41, further comprising storing the transaction information including the additional information in a database, wherein storing the transmitted transaction information and the additional identification information in the database facilitates subsequent collection on the promissory payment from the customer in the event that funds are not collected from the promissory payment.

50. The method of claim 41, wherein requesting additional information includes requesting the customer's telephone number.

51. The method of claim 41, wherein proffering the promissory payment includes proffering a payment by credit card, wherein evaluating the payment by credit card includes assessing the risk of accepting the credit card.

52. The method of claim 51, wherein requesting additional information includes requesting at least one of the purchase amount, an identification of the merchant, and credit card identification information related to the customer.

53. The method of claim 52, wherein proffering a payment by credit card includes obtaining credit card identification information from a magnetic strip on the credit card, wherein the magnetic strip comprises magnetically stored digital information that is indicative of the credit card identification information.
